(19) United States
(12) Patent Application Publication
(10) Pub. No.: US 2026/0362543 A1
(43) Pub. Date: Nov. 12, 2026

(54) HANDLING OF CONGESTION CONTROL TIMER FOR TRANSPORT OF USER DATA VIA CONTROL PLANE WHEN CONDITIONS EXISTING

(71) Applicant: MEDIATEK SINGAPORE PTE. LTD., Singapore (SG)

(72) Inventors: Marko NIEMI, Oulu (FI); Puneet ., Bengaluru (IN)

(73) Assignee: MEDIATEK SINGAPORE PTE. LTD., Singapore (SG)

(21) Appl. No.: 19/475,120

(22) PCT Filed: Sep. 11, 2024
(86) PCT No.: PCT/CN2024/118133

§ 371 Date: Oct. 14, 2025

(30) Foreign Application Priority Data
Oct. 11, 2023 (IN) 202321068344

(51) Int. Cl. H04W 76/28; H04W 28/02

(52) U.S. Cl. CPC H04W 76/28; H04W 28/0289

(57) ABSTRACT

Techniques pertaining to handling of congestion control timer for transport of user data via a control plane when conditions existing in mobile communications are described. An apparatus (e.g., a user equipment (UE)) determines that a condition exists while a timer T3448 is running. The apparatus keeps the timer T3448 running despite of the condition existing.

### CROSS REFERENCE TO RELATED PATENT APPLICATION(S)

The present disclosure claims the priority benefit of Indian Patent Application No. 202321068344, filed 11 Oct. 2023, the content of which herein being incorporated by reference in its entirety.

### TECHNICAL FIELD

The present disclosure is generally related to mobile communications and, more particularly, to handling of congestion control timer for transport of user data via a control plane when conditions existing in mobile communications.

### BACKGROUND

In wireless communications such as mobile communications under the current 3^{rd} Generation Partnership Project (3GPP) specification, if the congestion control for transport of user data via a control plane is active and if a user equipment (UE) has indicated support for a control plane data back-off timer, a network is to include a value for the control plane data back-off timer T3448 in an ATTACH ACCEPT, TRACKING AREA UPDATE ACCEPT, SERVICE ACCEPT, REGISTRATION ACCEPT or SERVICE REJECT message. Moreover, the network is to store a control plane data back-off time on a per-UE basis. The UE starts the timer T3448 with the value indicated in the message.

Under the current 3GPP specification, the timer T3448 would be stopped when: (1) the UE activates unavailability period duration; and/or (2) unavailability period is activated for discontinuous coverage; and/or (3) unavailability period is activated for other reasons (see 3GPP Technical Specification (TS) 24.501 subclause 5.3.26); and/or (4) access stratum is deactivated for 3GPP access; and/or (5) the unavailability period is activated; and/or (6) the access stratum is deactivated for discontinuous coverage; and/or (7) the access stratum is deactivated other reasons (see 3GPP TS 24.501 subclause 5.3.26); and/or (8) a mobile-initiated connection only (MICO) mode is activated; and/or (9) a power saving mode (PSM) is activated. However, if T3448 is to be stopped, the UE would face congestion control for transport of user data via the control plane, which would be undesirable. Therefore, there is a need for solutions of handling of congestion control timer for transport of user data via a control plane when conditions existing in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to handling of congestion control timer for transport of user data via a control plane when conditions existing (e.g., at unavailability period activation) in mobile communications. It is believed that implementations of one or more of the schemes proposed herein may address or otherwise alleviate the issues described above.

In one aspect, a method may involve a UE determining that a condition exists while a timer T3448 is running. The method may also involve the UE keeping the timer T3448 running despite of the condition existing.

In another aspect, an apparatus may include a transceiver configured to communicate wirelessly and a processor coupled to the transceiver. The processor may determine that a condition exists while a timer T3448 is running. The processor may also keep the timer T3448 running despite of the condition existing.

It is noteworthy that, although the description provided herein may be in the context of certain radio access technologies, networks, and network topologies such as 5th Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4th Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling of congestion control timer for transport of user data via a control plane when conditions existing in mobile communications. According to the present disclosure, a number of possible solutions may be implemented separately or jointly. That is, although these possible solutions may be described below separately, two or more of these possible solutions may be implemented in one combination or another.

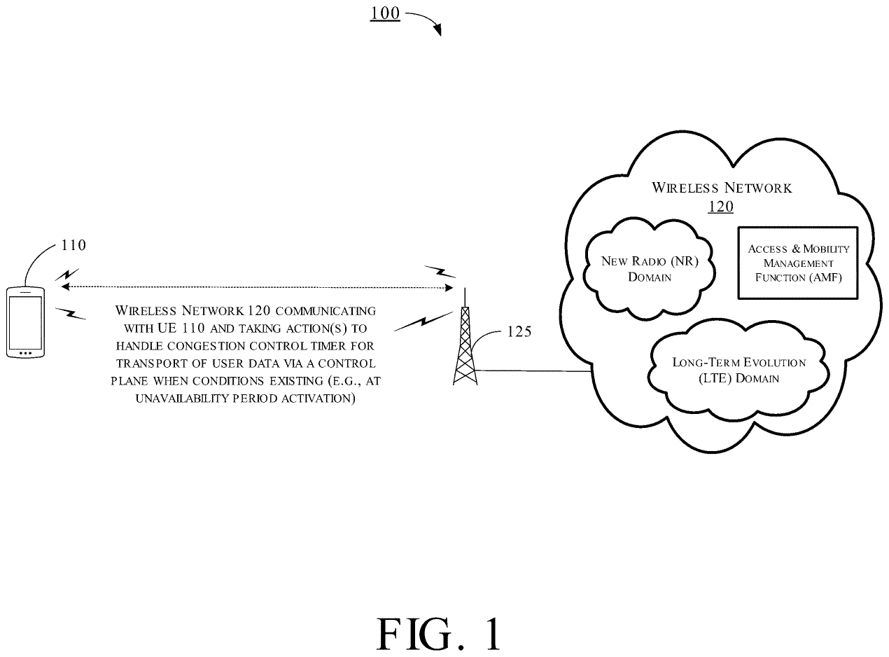

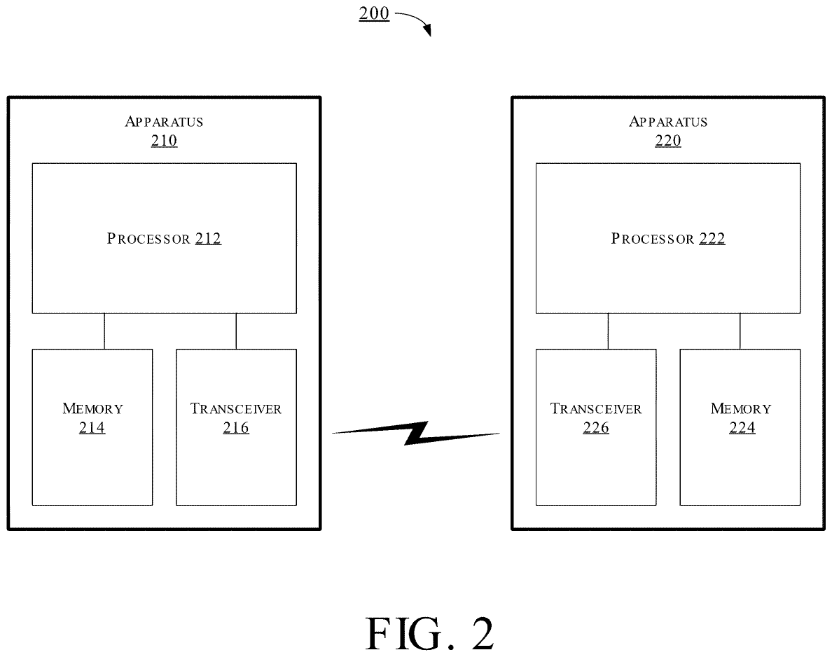

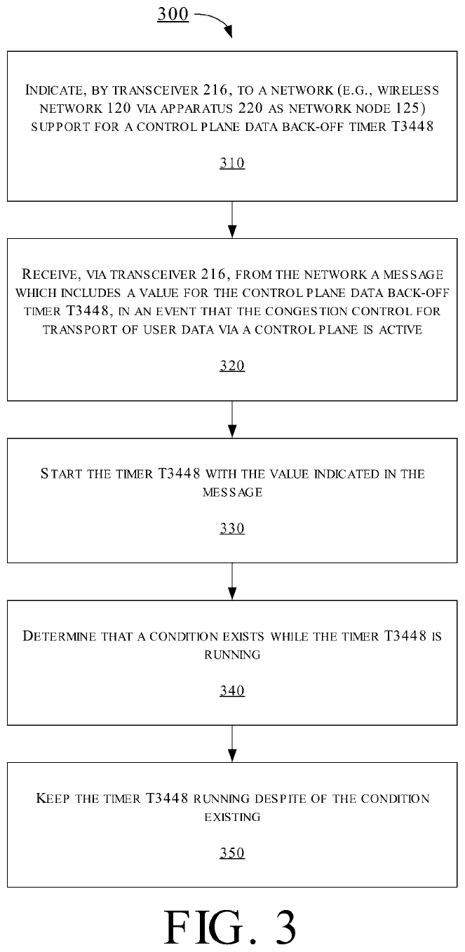

FIG. 1 illustrates an example network environment 100 in which various solutions and schemes in accordance with the present disclosure may be implemented. FIG. 2~FIG. 3 illustrate examples of implementation of various proposed schemes in network environment 100 in accordance with the present disclosure. The following description of various proposed schemes is provided with reference to FIG. 1~FIG. 3.

Referring to FIG. 1, network environment 100 may involve a UE 110, such as a mobile device or smartphone, in wireless communication with a wireless network 120 as part of a communication network. The wireless network 120 may be a PLMN including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to handling of congestion control timer for transport of user data via a control plane when conditions (e.g., at unavailability period activation) in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under the current 3GPP specification with respect to handling of congestion control for transport of user data via the control plane, network 120 may activate congestion control for transport of user data via the control plane, as specified in 3GPP TS 23.401. In case that congestion control for transport of user data via the control plane is active and in case UE 110 has indicated support for the control plane data back-off timer, network 120 is to include a value for the control plane data back-off timer T3448 in an ATTACH ACCEPT, TRACKING AREA UPDATE ACCEPT, SERVICE ACCEPT, REGISTRATION ACCEPT or SERVICE REJECT message. Moreover, in such a case, network 120 is also to store a control plane data back-off time on a per-UE basis. Correspondingly, UE 110 may start the timer T3448 with the value indicated in the message. To avoid a large number of UEs simultaneously initiating deferred requests, network 120 may select the value for the timer T3448 for the informed UEs so that timeouts are not synchronized.

Network 120 may send a TRACKING AREA UPDATE ACCEPT message or SERVICE ACCEPT message without a T3448 value information element (IE) to stop the timer T3448 running in UE 110 as specified in clause 5.5.3.2.4 and clause 5.6.1.4.2. Based on the stored control plane data back-off time for UE 110, network 120 may reject the transfer of user data via the control plane initiated by UE 110. While the timer T3448 is running, UE 110 in an EMM-IDLE mode may not initiate the transport of user data via the control plane procedure (see clause 6.6.4), except if UE 110 is allowed to use exception data reporting (see the ExceptionDataReportingAllowed leaf of the NAS configuration MO in 3GPP TS 24.368 or the USIM file EFNASCONFIG in 3GPP TS 31.102) and the user data is related to an exceptional event. Upon entering the state of EMM-DEREGISTERED or a new public land mobile network (PLMN) which is not equivalent to the PLMN where UE 110 started the timer T3448, or upon being switched off while the timer T3448 is running, UE 110 may stop the timer T3448.

Under various proposed schemes in accordance with the present disclosure, UE 110 may not stop timer T3448 (e.g., by keeping timer T3448 running), if the timer is already running, when one or more of a plurality of conditions exist(s). The plurality of conditions include, for example and not limited to, the following: (1) UE 110 activating an unavailability period; (2) the unavailability period being activated for a discontinuous coverage; (3) the unavailability period being activated for one or more reasons other than discontinuous coverage (see 3GPP TS 24.501 subclause 5.3.26); (4) an access stratum (AS) being deactivated for a 3GPP access; (5) the unavailability period being activated; (6) the AS being deactivated for the discontinuous coverage; (7) the AS being deactivated for one or more reasons other than discontinuous coverage (see 3GPP TS 24.501 subclause 5.3.26); (8) a MICO mode being activated; and (9) a PSM being activated.

Under one proposed scheme in accordance with the present disclosure with respect to MICO mode, when MICO mode is activated, all non-access stratum (NAS) timers may be stopped and associated procedures may be aborted except for timers T3512, T3346, T3447, T3396, T3584, T3585, any back-off timers, T3247, T3448, and the timer T controlling the periodic search for home public land mobile network (HPLMN) or equivalent HPLMN (EHPLMN) or higher prioritized PLMNs.

Under one proposed scheme in accordance with the present disclosure with respect to support for unavailability period, when the unavailability period is activated, all NAS timers may be stopped and associated procedures may be aborted except for timers T3512, T3346, T3447, T3396, T3584, T3585, any back-off timers, T3247, T3448, and the timer T controlling the periodic search for HPLMN or EHPLMN or higher prioritized PLMNs.

Under one proposed scheme in accordance with the present disclosure with respect to power saving mode (PSM), when PSM is activated, all NAS timers may be stopped and associated procedures may be aborted except for T3412, T3346, T3396, T3447, any backoff timers, T3448 and the timer T controlling the periodic search for HPLMN or EHPLMN (if the EHPLMN list is present) or higher prioritized PLMNs.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to handling of congestion control timer for transport of user data via a control plane when conditions existing in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to handling of congestion control timer for transport of user data via a control plane when conditions existing in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example process 300.

### Illustrative Processes

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to handling of congestion control timer for transport of user data via a control plane when conditions existing in mobile communications in accordance with the present disclosure. Process 300 may include one or more operations, actions, or functions as illustrated by one or more of blocks. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210, as a UE, indicating, via transceiver 216, to a network (e.g., wireless network 120 via apparatus 220 as network node 125) support for a control plane data back-off timer T3448. Process 300 may proceed from 310 to 320.

At 320, process 300 may involve processor 212 receiving, via transceiver 216, from the network a message which includes a value for the control plane data back-off timer T3448, in an event that the congestion control for transport of user data via a control plane is active. The message may be an ATTACH ACCEPT, TRACKING AREA UPDATE ACCEPT, SERVICE ACCEPT, REGISTRATION ACCEPT or SERVICE REJECT message. Process 300 may proceed from 320 to 330.

At 330, process 300 may involve processor 212 starting the timer T3448 with the value indicated in the message. Process 300 may proceed from 330 to 340.

At 340, process 300 may involve processor 212 determining that a condition exists while the timer T3448 is running. Process 300 may proceed from 340 to 350.

At 350, process 300 may involve processor 212 keeping the timer T3448 running despite of the condition existing.

In some implementations, the condition may involve the UE activating an unavailability period.

In some implementations, the condition may involve an unavailability period being activated for a discontinuous coverage.

In some implementations, the condition may involve an unavailability period being activated for one or more reasons other than a discontinuous coverage.

In some implementations, the condition may involve an AS being deactivated for a 3GPP access.

In some implementations, the condition may involve an unavailability period being activated.

In some implementations, the condition may involve an AS being deactivated for a discontinuous coverage.

In some implementations, the condition may involve an AS being deactivated for one or more reasons other than a discontinuous coverage.

In some implementations, the condition may involve a MICO mode being activated.

In some implementations, the condition may involve a PSM being activated.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), that a condition exists while a timer T3448 is running; and
keeping, by the processor, the timer T3448 running despite of the condition existing.

2. The method of claim 1, wherein the condition comprises the UE activating an unavailability period.

3. The method of claim 1, wherein the condition comprises an unavailability period being activated for a discontinuous coverage.

4. The method of claim 1, wherein the condition comprises an unavailability period being activated for one or more reasons other than a discontinuous coverage.

5. The method of claim 1, wherein the condition comprises an access stratum (AS) being deactivated for a 3rd Generation Partnership Project (3GPP) access.

6. The method of claim 1, wherein the condition comprises an unavailability period being activated.

7. The method of claim 1, wherein the condition comprises an access stratum (AS) being deactivated for a discontinuous coverage.

8. The method of claim 1, wherein the condition comprises an access stratum (AS) being deactivated for one or more reasons other than a discontinuous coverage.

9. The method of claim 1, wherein the condition comprises a mobile-initiated connection only (MICO) mode being activated.

10. The method of claim 1, wherein the condition comprises a power saving mode (PSM) being activated.

11. An apparatus implementable in a user equipment (UE), comprising:
a transceiver configured to communicate wirelessly; and
a processor coupled to the transceiver and configured to perform operations comprising:
determining that a condition exists while a timer T3448 is running; and
keeping the timer T3448 running despite of the condition existing.

12. The apparatus of claim 11, wherein the condition comprises the UE activating an unavailability period.

13. The apparatus of claim 11, wherein the condition comprises an unavailability period being activated for a discontinuous coverage.

14. The apparatus of claim 11, wherein the condition comprises an unavailability period being activated for one or more reasons other than a discontinuous coverage.

15. The apparatus of claim 11, wherein the condition comprises an access stratum (AS) being deactivated for a 3rd Generation Partnership Project (3GPP) access.

16. The apparatus of claim 11, wherein the condition comprises an unavailability period being activated.

17. The apparatus of claim 11, wherein the condition comprises an access stratum (AS) being deactivated for a discontinuous coverage.

18. The apparatus of claim 11, wherein the condition comprises an access stratum (AS) being deactivated for one or more reasons other than a discontinuous coverage.

19. The apparatus of claim 11, wherein the condition comprises a mobile-initiated connection only (MICO) mode being activated.

20. The apparatus of claim 11, wherein the condition comprises a power saving mode (PSM) being activated.
